(19) United States
(12) Patent Application Publication
(10) Pub. No.: US 2023/0339339 A1
(43) Pub. Date: Oct. 26, 2023

(54) CHARGING APPARATUS FOR PERSONAL MOBILITY MEANS

(71) Applicant: LG ELECTRONICS INC., Seoul (KR)

(72) Inventors: Sungpil KIM, Seoul (KR); Samyoup KIM, Seoul (KR); Jong Kyu JU, Seoul (KR); Hyunghoon PARK, Seoul (KR); Jaemyo SHIM, Seoul (KR)

(73) Assignee: LG ELECTRONICS INC., Seoul (KR)

(21) Appl. No.: 18/246,640

(22) PCT Filed: Feb. 3, 2021
(86) PCT No.: PCT/KR2021/001430

§ 371 Date: Mar. 24, 2023

(30) Foreign Application Priority Data
Sep. 24, 2020 (KR) 10-2020-0123764

(51) Int. Cl. B60L 53/12; B60L 53/31; B60L 53/38

(52) U.S. Cl. CPC B60L 53/12; B60L 53/31; B60L 53/38; B60L 2200/24

(57) ABSTRACT

The present disclosure relates to a charging device for a personal mobility vehicle, and in particular, a charging device for a personal mobility vehicle comprising a first charging unit creating a magnetic field for wireless charging, a second charging unit converting a magnetic field, delivered through the first charging unit, into a power source and charging a battery provided in a personal mobility vehicle, a stand storing a personal mobility vehicle in an upright position, and a variable support unit moving the first charging unit, based on a position of the second charging unit.

### TECHNICAL FIELD

The present disclosure relates to a charging device for a personal mobility vehicle, in which a charging position varies depending on the position of a personal mobility vehicle.

### BACKGROUND ART

Personal mobility vehicles can ordinarily comprise electric wheels, electric scooters, electric bikes, micro electric vehicles and the like that are powered by electricity.

Electric scooters, usually used as a personal transporter, can comprise a skate board-shaped body, a support bar elongated to the upper side of the body, a handle elongated to both sides of the support bar, and wheels rotatably installed at the body and the support bar.

Personal transporters comprise a motor supplying rotational power, and a battery supplying a power source to the motor.

Conventional personal transporters have a different size, a different charging terminal position, and the like depending on their models. Accordingly, each personal mobility vehicle needs to be provided with an exclusive charging device, depending on its model, causing an increase in the costs of installing the charging device.

Additionally, in the case where the charging terminal of a personal mobility vehicle and the charging terminal of a stand do not contact each other and are spaced from each other, charging efficiency deteriorates.

The background art of the present disclosure is disclosed in KR Patent Publication No. 10-2020-0085964 (published on Jul. 16, 2020 and titled Electric Kickboard).

### DESCRIPTION OF INVENTION

### Technical Problems

The objective of the present disclosure is to provide a charging device for a personal mobility vehicle, which can be commonly applied to personal mobility vehicles having a different charging position.

The objective of the present disclosure is to provide a charging device for a personal mobility vehicle, which induces contact between a charging terminal of a personal mobility vehicle and a charging terminal of a stand, ensuring improvement in charging efficiency.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

To solve the above-mentioned problems, a charging device for a personal mobility vehicle, in the present disclosure, is characterized in that the position of a first charging unit varies depending on the position of a second charging unit fixed to a personal mobility vehicle.

Specifically, a variable support unit operates to move the first charging unit, based on the position of the second charging unit, such that the first charging unit keeps contacting the second charging unit.

Additionally, a first supporter provided in the variable support unit may support the first charging unit rotatably. Additionally, a second supporter provided in the variable support unit may change the position of the first charging unit in the up-down direction. Further, a third supporter provided in the variable support unit may change the position of the first charging unit in the front-rear direction, while moving in the front-rear direction.

In the present disclosure, a first magnet provided in the first charging unit is moved by the magnetic force of a second magnet provided in the second charging unit, to induce the first charging unit and the second charging to face each other.

Specifically, since the first magnet provided in the first charging unit moves toward the second magnet provided in the second charging unit, the first charging unit moves based on the position of the second charging unit, and a position for charging varies.

The charging device for a personal mobility vehicle according to the present disclosure may comprise at least any one of a stand, a first charging unit, a second charging unit and a variable support unit.

The first charging unit may generate a magnetic field for wireless charging. The second charging unit may be mounted in a personal mobility vehicle. Additionally, the second charging unit may convert a magnetic field, delivered through the first charging unit, into a power source, and charge a battery provided in the personal mobility device. In the state where the first charging unit and the second charging unit do not contact each other, the position of the first charging unit may vary depending on the position of the second charging unit.

Further, the personal mobility vehicle may be stored at the stand, in an upright position.

The variable support unit may be fixed to the stand while supporting the first charging unit. Additionally, the variable support unit may move the first charging unit, based on the position of the second charging unit. The variable support unit may comprise a first supporter that supports the first charging unit rotatably.

The first supporter may comprise at least any one of a first body, a first side member, a stopper and a buffer member. The first body may be spaced from the first charging unit and elongated in the up-down direction. Additionally, the first side member may be elongated from both sides of the first body to the front at which the first charging unit is disposed. Further, the first side member may rotatably support the first charging unit. The stopper may protrude to the front of the first body. Additionally, the stopper may limit the rotation of the first charging unit while contacting the first charging unit rotating at a predetermined angle or greater.

The buffer member may be disposed between the stopper and the first charging unit, and as the first charging unit rotates toward the stopper, may reduce an impact.

The variable support unit may further comprise a second supporter being disposed outside the first supporter, and guiding the up-down movement of the first supporter. The second supporter may comprise at least any one of a second body, a guide bar, a first elastic supporter, a second elastic supporter and a side projection.

The second body may be disposed in a way that surrounds a lateral surface and a rear of the first supporter. The guide bar may be fixed to the second body while passing through the first supporter in the up-down direction. The first elastic supporter may be disposed between the upper side of the first supporter and the second body, and pressurize the first supporter downward. The second elastic supporter may be disposed between the lower side of the first supporter and the second body, and pressurize the first supporter upward. Additionally, the elastic force of the second elastic supporter may be greater than that of the first elastic supporter.

The variable support unit may comprise a third supporter being disposed outside the second supporter and being mounted on the stand. The third supporter may guide the front-rear movement of the second supporter. Additionally, the third supporter may comprise at any one of a third body, a link part, a shaft, an elastic member, a movement guide and a movement block.

The third body may be disposed outside the second supporter and fixed to the stand. The link part may connect the third body and the second supporter. The link shape the link part may change based on the front-rear movement of the second supporter. The shaft may connect the link part that is disposed on both lateral surfaces of the second supporter.

The link part may comprise at least any one of a first link, a second link and a link shaft. The first link may be elongated in a straight line shape. The second link may connect to the first link rotatably, across the first link. One side of the first link and one side of the second link may connect to the shaft.

The shaft may comprise a first shaft connecting to the first link. Additionally, the shaft may comprise a second shat being disposed in parallel with the first shaft and connecting to the second link.

Further, the first charging unit may comprise at least any one of a first housing, a transmission controller, a transmission coil and first magnet. The first housing may be fixed to the stand. The transmission controller may be installed inside the first housing. The transmission coil may be disposed inside the first housing, and connect to the transmission controller. The first magnet maybe fixed to the first housing and have magnetic force.

Furthermore, the second charging unit may comprise at least any one of a second housing, a reception controller, a reception coil and a second magnet. The second housing may be fixed to the personal mobility vehicle. The reception controller may be installed inside the second housing. The reception coil may be disposed inside the second housing, and connect to the reception controller. The second magnet may be fixed to the second housing and have magnetic force of polarity different from polarity of the first magnet.

### Advantageous Effects

In a charging device for a personal mobility vehicle, according to the present disclosure, the position of a first charging unit varies depending on the position of a second charging unit fixed to a personal mobility vehicle, such that the charging device can be commonly applied to personal mobility vehicles having a different charging terminal position, ensuring a reduction in the costs of installing the charging device.

In the charging device for a personal mobility vehicle, a variable support unit operates to change the position of the first charging unit, based on the position of the second charging unit installed in a personal mobility vehicle, ensuring improvement in charging efficiency.

In the charging device for a personal mobility vehicle, the position of the first charging unit is changed by a magnet provided in the first charging unit and the second charging unit, such that the first charging unit moves to a position in which the first charging unit faces the second charging unit, ensuring improvement in charging efficiency.

Specific effects are described along with the above-described effects in the section of detailed description.

### BRIEF DESCRIPTION OF DRAWINGS

FIG. 1 is a perspective view showing that a personal mobility vehicle is held at a charging device for a personal mobility vehicle in one embodiment.

FIG. 2 is a perspective view showing the charging device for a personal mobility vehicle in one embodiment.

FIG. 3 is a perspective view showing that a first charging unit is disposed at a variable support unit in one embodiment.

FIG. 4 is an exploded perspective view showing the variable support unit in one embodiment.

FIG. 5 is a perspective view showing that a second supporter connects to a first supporter in one embodiment.

FIG. 6 is a cross-sectional view showing that a second charging unit is at the front of the first charging unit in one embodiment.

FIG. 7 is a cross-sectional view showing that the first charging unit moves upward along the second charging unit in one embodiment.

FIG. 8 is a cross-sectional view showing that the first charging unit moves downward along the second charging unit in one embodiment.

FIG. 9 is a view showing a connection state of a link part in one embodiment.

FIG. 10 is a view showing the link part in the state where the first supporter moves forward in one embodiment.

FIG. 11 is a view showing that the first charging unit is disposed at the first supporter in one embodiment.

FIG. 12 is a view showing that the second charging unit contacts the first charging unit in one embodiment.

FIG. 13 is a view showing that the first charging unit is in contact with the second charging unit while rotating, in one embodiment.

FIG. 14 is a view showing that the first charging unit is moved toward the inside of a third body in one embodiment.

FIG. 15 is a view showing that the first charging unit is moved toward the outside of the third body in one embodiment.

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can embody the technical spirit of the disclosure easily. In the disclosure, detailed description of known technologies in relation to the subject matter of the disclosure is omitted if it is deemed to make the gist of the disclosure unnecessarily vague. Hereafter, preferred embodiments according to the disclosure are specifically described with reference to the accompanying drawings. In the drawings, identical reference numerals can denote identical or similar components.

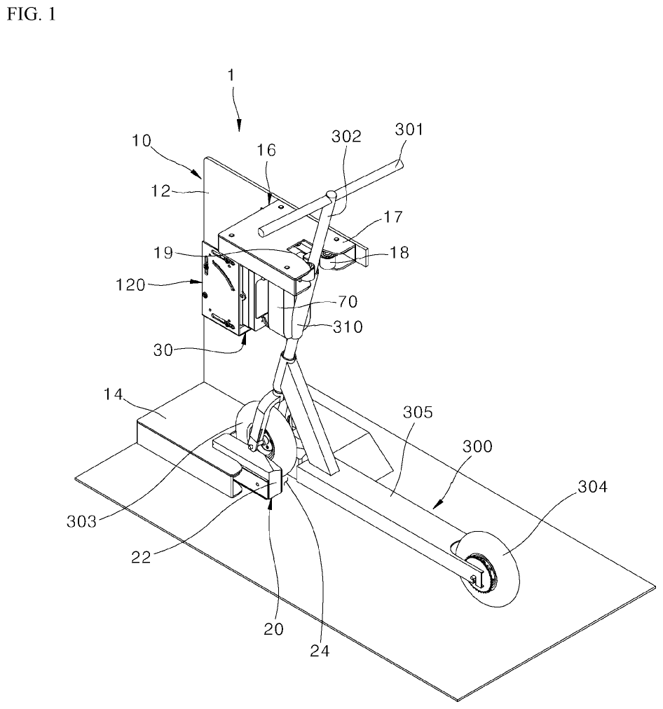

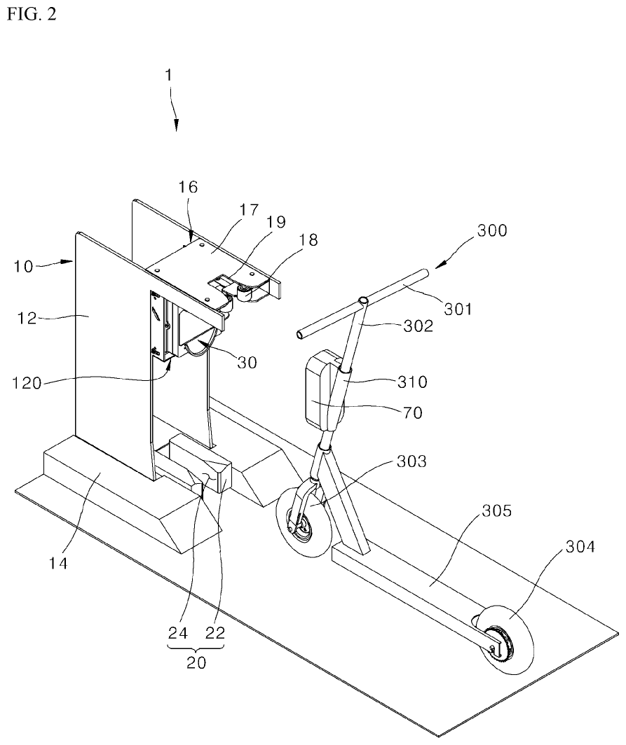

FIG. 1 is a perspective view showing that a personal mobility vehicle 300 is held at a charging device 1 for a personal mobility vehicle in one embodiment, and FIG. 2 is a perspective view showing the charging device 1 for a personal mobility vehicle in one embodiment.

As illustrated in FIGS. 1 and 2, the charging device 1 for a personal mobility vehicle in one embodiment may comprise at least any one of a stand 10, a first charging unit 30, a second charging unit 70, and a variable support unit 120.

In the present disclosure, since the first charging unit 30 is movably installed by the variable support unit 120, the position of the first charging unit 30 varies, depending on the position of the second charging unit 70 mounted on the personal mobility vehicle 300, to keep the first charging unit 30 contacting the second charging unit 70.

The stand 10 may be modified in various different forms, within the technical scope where the personal mobility vehicle 300 is stored in an upright position. The stand 10 supports a rotation column 302 at the same time as the stand 10 supports a front wheel 303 of the personal mobility vehicle 300. Accordingly, the stand 10 may limit the movement of the personal mobility vehicle 300. The stand 10 in one embodiment may comprise a fixation frame 12, a base 14, a first guide 16, and a second guide 20.

The fixation frame 12 may be elongated in the up-down direction, and when necessary, may be comprised of a plurality of members. The fixation frame 12 in one embodiment is formed into plates that are disposed in parallel with each other, and the first guide 16 and the second guide 20 are disposed between the fixation frames 12. Additionally, the lower side of the fixation frame 12 is fixed to the base 14. The base 14 may be installed in the state of being fixed to the ground surface. Further, the base 14 may be structures that are disposed in parallel, together with the fixation frame 12, such that a front wheel 303 or a rear wheel 304 of the personal mobility vehicle 300 may move to and sit in the inner side of the base part 14, but may be modified in various different forms.

The stand 10 and the fixation frame 12 may form a single module, and be installed, managed and repaired as a module, reducing time and costs spent installing, managing and repairing a module comprised of the stand 10 and the fixation frame 12.

Further, a plurality of modules comprising the stand 10 and the fixation frame 12 may be installed one after another. Thus, a plurality of personal mobility vehicles 300 may be held and charged at the same time.

The first guide 16 may be fixed to the fixation frame 12, and modified in various different forms within the technical scope where the first guide 16 is provided with a groove for mounting the rotation column 302 of the personal mobility vehicle 300 inside the first guide 16. The first guide 16 in one embodiment may comprise a guide body 17, a guide roller 18 and a body guide groove 19.

The guide body 17 is installed in the horizontal direction, and both lateral surfaces of the guide body 17 are fixed to the fixation frame 12. The guide body 17 has a groove thereinside, and the groove is elongated to the front of the guide body 17, and forms the body guide groove 19. The rotation column 302 of the personal mobility vehicle 300 moves along the body guide groove 19 and sits in the body guide groove 19.

Further, the guide roller 18 is rotatably disposed at the guide body 17 disposed at the entrance of the body guide groove 19. The guide roller 19 is disposed at both sides of the guide body 17 in the widthwise direction thereof, and the body guide groove 19 is disposed between the guide rollers 18. Accordingly, in the case where the rotation column 302 enters toward the guide roller 18 instead of entering toward the body guide groove 19, the guide roller 18 contacting the rotation column 302 reduces friction between the rotation column 302 and the guide roller 18, while the guide roller 18 rotates. Additionally, the rotation column 302 is guided by the guide roller 18 to the inside of the body guide groove 19.

The second guide 20 may be modified in various different forms within the technical scope where the second guide 20 is provided with a groove in which the wheels of the personal mobility vehicle 300 sit. The second guide 20 in one embodiment may be a structure that is fixed to the bottom part to guide the wheels of the personal mobility vehicle 300. Additionally, the second guide 20 guides the wheels to guide the personal mobility vehicle 300 to the front of the first charging unit 30. The second guide 20 in one embodiment comprises a guide member 22 and a guide groove 24.

The guide member 22 is provided with a guide groove 24 in which the front wheel 303 of the personal mobility vehicle 300 sits, and is fixed to the fixation frame 12 or the base 14. The guide member 22 is disposed in parallel at both sides of the guide groove 24.

The guide member 22 in one embodiment is disposed at both sides of the front wheel 303 in the widthwise direction thereof, and may move to both sides thereof in the widthwise direction thereof while being pushed by the front wheel 303. Additionally, the guide member 22 pressurizes the lateral surfaces of the front wheel, with elastic force, and prevents the personal mobility vehicle 300 from falling.

The guide groove 24 provided inside the guide member 22 guides the front wheel 303 in the front-rear direction, and is elongated straight along the guide member 22.

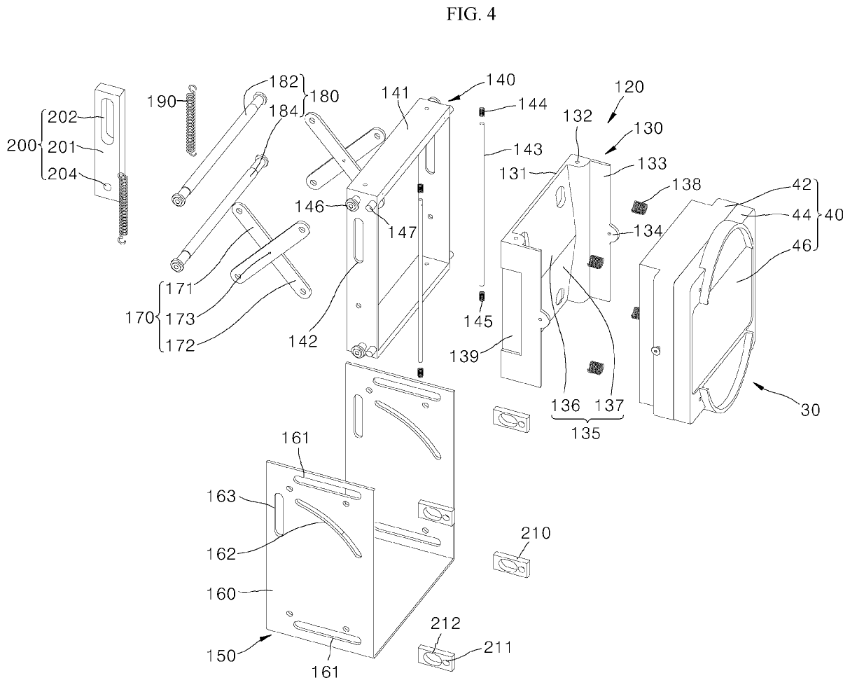

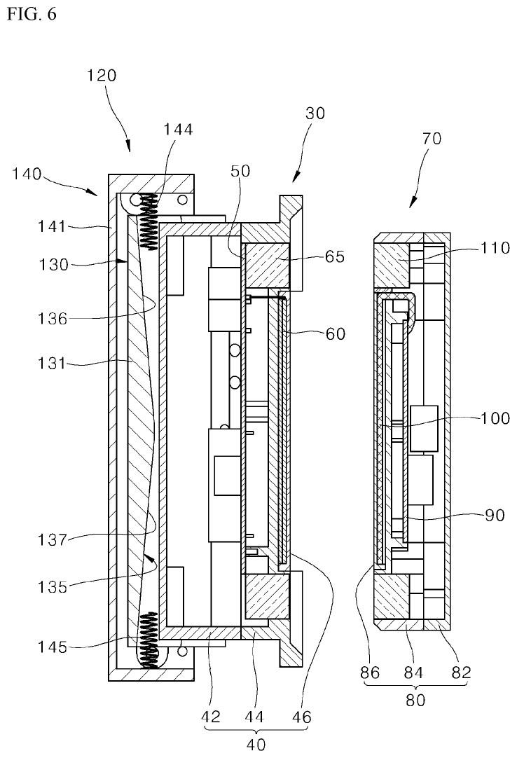

FIG. 4 is an exploded perspective view showing the variable support unit 120 in one embodiment, and FIG. 6 is a cross-sectional view showing that a second charging unit 70 is at the front of the first charging unit 30 in one embodiment.

As illustrated in FIGS. 2, 4 and 6, the first charging unit 30 may be installed toward the personal mobility vehicle 300, at the stand 10, and modified in various different forms within the technical scope where the first charging unit 30 generates a magnetic field for wireless charging. The first charging unit 30 in one embodiment may comprise at least any one of a first housing 40, a transmission controller 50, a transmission coil 60 and a first magnet 65.

The magnetic field for wireless charging, generated by the first charging unit 30, is transferred to the second charging unit 70 at the personal mobility vehicle 300 and charges a battery built into the personal mobility vehicle 300, reducing the risk of electric shock accidents.

Additionally, the first charging unit 30 may be installed in the state of being fixed to the fixation frame 12 of the stand 10, and when necessary, disposed at the variable support unit 120 the position of which can change such that the position of the first charging unit 30 changes.

In the case where the first charging unit 30 is disposed at the variable support unit 120, the position of the first charging unit 30 changes to be aligned with the position of the second charging unit 70 at the personal mobility vehicle 300, even if the position of the second charging unit 70 changes, such that the first charging unit 30 and the second charging unit 70 keep contacting each other, thereby ensuring the reliable charge of a battery.

The first housing 40 is mounted on the variable support unit 120 such that the position of the first housing 40 changes, and has a mounting space therein. Additionally, since the first housing 40 is formed with a non-metal and non-magnetic material, electricity may be blocked from moving from the inner side of the first housing 40 to the stand 10.

Further, the first housing 40 may be comprised of a plurality of members, when necessary. The first housing 40 in one embodiment may comprise a first housing body 42, a first core member 44, and a first cover member 46.

The first housing body 42 is fixed to a first supporter 130 provided at the variable support unit 120, and is provided with an entrance being toward the second charging unit 70. Since the first housing body 42 is rotatably disposed on the lateral surface of the first supporter 130, the first housing body 42 protrudes further outward than the first supporter 130. The first housing body 42 may be made of a material comprising an aluminum alloy of high thermal conductivity, for heat dissipation, or an insulation material such as plastics.

The first core member 44 is fixed to the first housing body 42, with the transmission controller 50 between the first core member 44 and the first housing body 42. The first core member 44 may comprise an aluminum alloy, for heat dissipation, and may also be formed with a material having high thermal conductivity. A cable connecting to the transmission controller 50 that is disposed between the first core member 44 and the first housing body 42 extends to the outside of the first housing 40. The first core member 44 may be disposed between the transmission controller 50 and the transmission coil 60, and serve as a partition for blocking the transfer of a magnetic field generated by the transmission coil 60 to the transmission controller 50.

The transmission coil 60 is disposed between the first cover member 46 and the first core member 44, and the first cover member 46 is coupled to the outer side of the first core member 44. The first cover member 46 may be formed with plastics, and cover the transmission coil 60 such that the transmission coil 60 is not exposed to the outside.

The transmission controller 50 may be installed inside the first housing 40. The transmission controller 50 comprises a control element that supplies a power source to the transmission coil 60 to form a magnetic. The control element is mounted on a printed circuit board and constitutes the transmission controller 50.

The transmission coil 60 may be disposed inside the first housing 40, and connect to the transmission controller 50. The first core member 44 is installed between the transmission coil 60 and the transmission controller 50, and a cable that is supplied with a power source connects the transmission coil 60 and the transmission controller 50.

The transmission coil 60 is disposed between the first core member 44 and the first cover member 46, and a coil is spirally wound around the transmission coil 60. The transmission coil 60 generates a magnetic field for charging, toward the front at which the second charging unit 70 is placed. The transmission coil 60 may be fixed to a plate-shaped member, to maintain its shape in which a coil is wound.

The first magnet 65 is fixed to the first housing 40 and has magnetic force. A permanent magnet is used as the first magnet 65, and a plurality of first magnets 65 may be disposed at the first core member 44. The first magnet 54 in one embodiment is disposed respectively at the upper side and the lower side of the transmission coil 60, and fixed to the first core member 44.

The second charging unit 70 may comprises a receiver circuit receiving wireless electricity, and be fixed to a personal mobility vehicle 300 having various sizes, thereby reducing initial installation costs. The second charging unit 70 may be fixed to the rotation column 302 of the personal mobility vehicle 300, through a charging bracket 310, and may be commonly used for various types of personal mobility vehicles 300 only by replacing a charging bracket 310 of a personal mobility vehicle 300 of different models.

The second charging unit 70 may be mounted on the personal mobility vehicle 300, and modified in various different forms within the technical scope where the second charging unit converts a magnetic field delivered through the first charging unit 30 into a power source, and charges a battery provided at the personal mobility vehicle 300. The second charging unit 70 in one embodiment may comprise at least any one of a second housing 80, a reception controller 90, a reception coil 100, and a second magnet 110.

The first charging unit 30 disposed at the stand 10 forms a magnetic field for charging, and the second charging unit 70 disposed at the personal mobility vehicle 300 receives the magnetic field and charges the battery of the personal mobility vehicle 300, thereby preventing electric shock accidents.

The second housing 80 may be directly fixed to the rotation column 302 of the personal mobility vehicle 300. Alternatively, the second housing 80 is fixed to the charging bracket 310 such that the movement of the second housing 80 is limited, and the charging bracket 310 in which the second housing 80 is installed may be fixed to the rotation column 302. The second housing 80 may have a mounting space therein, and be made of a non-metal and non-magnetic material. The second housing 80 in one embodiment may be comprised of a plurality of members, and comprise a second housing body 82, a second core member 84, and a second cover member 86.

The second housing body 82 is fixed to the charging bracket 310 and has an entrance that is open toward a first measuring unit.

The second core member 84 is fixed to the second housing body 82, and the reception controller 90 is disposed between the second core member 84 and the second housing body 82. The second core member 84 may be formed with a material comprising an aluminum alloy of high thermal conductivity, for heat dissipation, and formed into a partition that partitions a space in which the reception controller 90 and the reception coil 100 are installed. Accordingly, a magnetic field transferred to the reception controller 90 is blocked by the second core member 84, and the damage to the reception controller 90, caused by the magnetic field, may be prevented.

The reception controller 90 is disposed between the second core member 84 and the second housing body 82, and a cable connecting to the reception controller 90 extends to the outside of the second housing 80.

The second cover member 86 is fixed to the second core member 84 with the reception coil 100 between the second cover member 86 and the second core member 84. The second cover member may be formed with plastics. Additionally, the second cover member 86 may prevent the reception coil 100 from being exposed to the outside.

According to the present disclosure, the first guide 16 and the second guide 20 that support the personal mobility vehicle 300, and the first charging unit 30 and the second charging unit 70 that wirelessly charge the battery of the personal mobility vehicle 300 are included, such that the personal mobility vehicle 300 is charged and stored as the personal mobility vehicle 300 is returned, thereby ensuring improvement in the ease of use.

The reception controller 90 may be installed inside the second housing 80, and supply a power source, delivered through the reception coil 100, to the battery provided at the personal mobility vehicle 300. Additionally, the reception controller 90 may comprise a control element for converting a received magnetic field into a power source. The control element may be mounted on a printed circuit board, and constitute the reception controller 90.

Additionally, the reception coil 100 may be disposed inside the second housing 80, and connect to the reception controller 90. Since the second core member 84 is disposed between the reception coil 100 and the reception controller 90, a cable that is supplied with a power source passes through the second core member 84, and connects the transmission coil 60 and the transmission controller 50.

The reception coil 100 is disposed between the second core member 84 and the second cover member 86, and a coil is spirally wound around the reception coil 100. The surface area of the reception coil 100 is the same as or less than the surface area of the transmission coil 60. Thus, even if the second charging unit 70 comprising the reception coil 100 is not aligned with the first charging unit 30, the reception coil 100 is highly likely to be disposed inside the transmission coil 60, such that wireless charging is performed more rapidly and readily.

Conventionally, the personal mobility vehicle 300 is collected and moved to a garage and then charged conventionally, increasing the risk of damage to the personal mobility vehicle and the costs of charging, in the case where the personal mobility vehicle 300 is charged. However, according to the present disclosure, the personal mobility vehicle 300 is charged as the personal mobility vehicle is returned, preventing damage to the personal mobility vehicle and reducing the costs of charging.

The second magnet 110 may be fixed to the second housing 80 and have magnetic force. A permanent magnet may be used as the second magnet 110, and a plurality of second magnets 110 may be disposed at the second core member 84. The second magnet 110 in one embodiment is disposed respectively at the upper side and the lower side of the reception coil 100, and fixed to the second core member 84. Further, the second magnet 110 may have magnetic force of polarity different from polarity of the first magnet 65.

A permanent magnet may be used as the first magnet 65, but when necessary, an electromagnet may also be used as the first magnet 65. Further, any one of the first magnet 65 and the second magnet 110 may be made of a magnet, while the other is made of iron. The first magnet 65 and the second magnet 110 may be modified in various different forms.

Since the first magnet 65 is provided at the first charging unit 30, and the second magnet 110 is provided at the second charging unit 70, the position of the first charging unit 30 may vary depending on the position of the second charging unit 70, in the state where the first charging unit 30 and the second charging unit 70 do not contact each other. The first magnet 65 and the second magnet 110 have opposite polarity and generate attractive force therebetween.

That is, since the first magnet 65 provided at the first charging unit 30 is moved by the second magnet 110 provided at the second charging unit 70, the first charging unit 30 may move in the state where the first charging unit 30 and the second charging unit 70 face each other. Thus, in the state where the first charging unit 30 and the second charging unit 70 contact each other, the first charging unit 30 and the second charging unit 70 may keep contacting each other, with the help of the magnetic force of the first magnet 65 and the second magnet 110. Further, the first charging unit 30 and the second charging unit 70 may be separated from each other by external force greater than the magnetic force of the first magnet 65 and the second magnet 110.

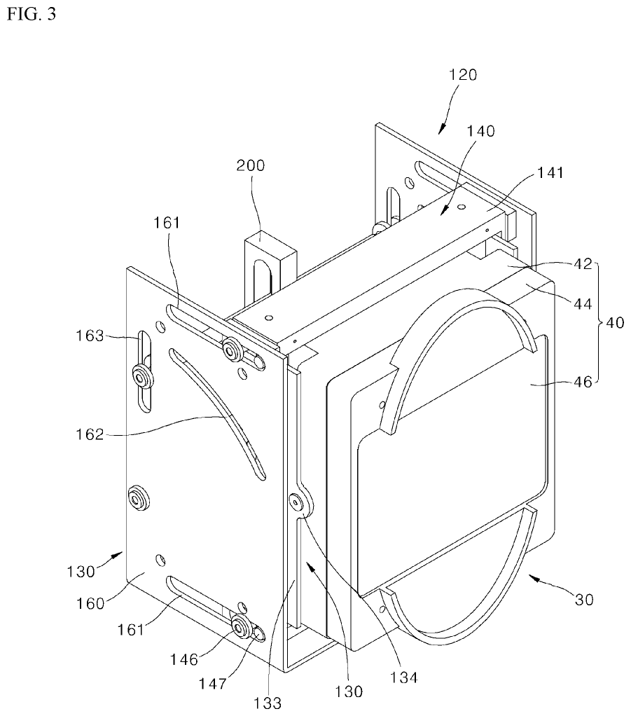

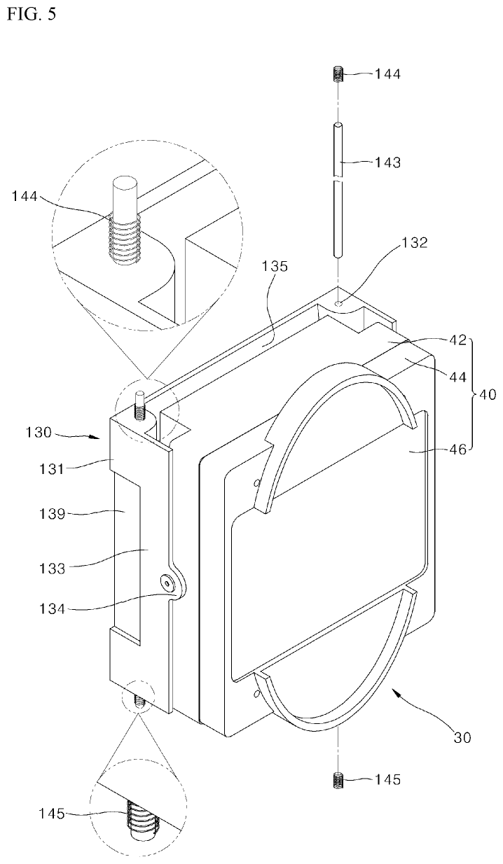

FIG. 3 is a perspective view showing that a first charging unit 30 is disposed at a variable support unit 120 in one embodiment, and FIG. 5 is a perspective view showing that a second supporter 140 connects to a first supporter 130 in one embodiment.

As illustrated in FIGS. 3 to 5, the variable support unit 120 may be fixed to the stand 10 while supporting the first charging unit 30, and modified in various different forms within the technical scope where the variable support unit 120 moves the first charging unit 30, based on the position of the second charging unit 70. The variable support unit 120 in one embodiment may comprise a first supporter 130, a second supporter 140, and a third supporter 150.

The first supporter 130 may be modified in various different forms within the technical scope where the first supporter 130 rotatably supports the first charging unit 30. The first supporter 130 in one embodiment may comprise at least any one of a first body 131, a first side member 133, a stopper 135 and a restoration member.

Since the first supporter 130 provided at the variable support unit 120 rotatably supports the first charging unit 30, the first charging unit 30 may rotate around a rotation support projection 134. The first supporter 130 in one embodiment may comprise at least any one of a first body 131, a first side member 133, a stopper 135 and a buffer member 138.

The first body 131 may be spaced from the first charging unit 30, and elongated in the up-down direction. The first body 131 may be formed into a plate or a partition, and the first side member 133 may be disposed at both sides of the first body 131.

The first side member 133 is elongated from both the sides of the first body 131 to the front at which the first charging unit 30 is disposed. The first side member 133 may be formed into a plate, and rotatably support a rotation shaft provided on the lateral surface of the first charging unit 30. Since the rotation support projection 134 provided at the first side member 133 rotatably supports the rotation shaft of the first charging unit 30, the first charging unit 30 can rotate around the rotation support projection 134, within a range of predetermined angles.

The stopper 135 may be formed into a projection protruding to the front of the first body 131, and limit the rotation of the first charging unit 30 while contacting the first charging unit 30 rotating at the predetermined angles or greater.

The stopper 135 in one embodiment has a longitudinal cross section of a triangle, and is provided with an upper inclination part 136 where the thickness of the stopper 135 decreases gradually from the center of the stopper 135 toward the upper side of the stopper 135. Additionally, the stopper 135 may be provided with a lower inclination part 137 where the thickness of the stopper 135 decreases gradually from the center of the stopper 135 toward the lower side of the stopper 135.

The buffer member 138 using a coil spring may be disposed between the stopper 135 and the first charging unit 30. A plurality of buffer members 138 is disposed between the upper inclination part 136 and the first charging unit 30, and a plurality of buffer members 138 is also disposed between the lower inclination part 137 and the first charging unit 30. In the case where the first charging unit 30 is rotated toward the upper inclination part 136 or the lower inclination part 137 by external force, the first charging unit 30 is returned to an initial position by the restoring force of the buffer member 138 in the state where the external force is removed. The initial position of the first charging unit 30 is a position in which the first charging unit 30 stands upright at the front of the variable support unit 120. Additionally, the buffer member 138 may be disposed between the stopper 135 and the first charging unit 30 and reduce an impact at a time where the first charging unit 30 rotates toward the stopper 135.

Additionally, the first body 131 may have a side groove 139 forming a concave groove, on the lateral surface thereof. The side groove 139 forms a concave groove to avoid interference with a link part 170 described hereafter, as the link part 170 operates, thereby ensuring improvement in the operational reliability of the variable support unit 120.

Further, the first body 131 has a guide hole 132 that is a hole penetrating in the up-down direction, at both the sides thereof.

The second supporter 140 provided at the variable support unit 120 may change the position of the first charging unit 30 in the up-down direction. The second supporter 140 may be disposed outside the first supporter 130, and modified in various different forms within the technical scope where the second supporter 140 guides the up-down movement of the first supporter 130. The second supporter 140 in one embodiment may comprise at least any one of a second body 141, a guide bar 143, a first elastic supporter 144, a second elastic supporter 145, a first side projection 146 and a second side projection 147.

The second body 141 may be disposed in a way that surrounds the side and rear of the first supporter 130. The second body 141 may be provided with a rectangular frame that surrounds the outer perimeter of the first supporter 130. The second body 141 has a side guide hole that forms an elongated hole in the up-down direction, on the lateral surface thereof.

The guide bar 143 may be fixed to the second body 141 while passing through the first supporter 130 in the up-down direction. In one embodiment, a pair of guide bars 143 is installed in parallel. The guide bar 143 is installed in the up-down direction while passing through the guide hole 143 provided at the first supporter 130, and the upper end and the lower end of the guide bar 143 are fixed to the second body 141.

The first elastic supporter 144 may be disposed between the upper side of the first supporter 130 and the second body 141, and pressurize the first supporter 130 downward. Additionally, the second elastic supporter 145 may be disposed between the lower side of the first supporter 130 and the second body 141, and pressurize the first supporter 130 upward.

The first elastic supporter 144 and the second elastic supporter 145 may use a coil spring or an elastic body, and be installed such that the elastic force of the second elastic supporter 145 may be greater than the elastic force of the first elastic supporter 144. The elastic force of the second elastic supporter 145 is greater than the elastic force of the first elastic supporter 144, considering the self-weight of the first supporter 130 and the first charging unit 30. Thus, a balance can be created between the forces of the first elastic supporter 144 and the second elastic supporter 145 that pressurize the upper side and the lower side of the first supporter 130.

The first side projection 146 and the second side projection 147 protruding from the lateral surface of the second body 141 are formed into a projection, and connect to a movement block and a third body 160 that are described hereafter.

The third supporter 150 may change the position of the first charging unit 30 in the front-rear direction, while moving in the front-rear direction. The third supporter 150 may be disposed outside the second supporter 140 and modified in various different forms within the technical scope where the third supporter 150 guides the front-rear movement of the second supporter 140. The third supporter 150 in one embodiment may comprise at least any one of a third body 160, a link part 170, a shaft 180, an elastic member 190, a movement guide 200 and a movement block.

The third body 160 may be disposed outside the second supporter 140, and fixed to the stand 10. The third body 160 may be modified in various different forms within the technical scope where the third body 160 is disposed outside both lateral surfaces of the second body 141. The third body 160 in one embodiment is a member formed into a “E”-shaped plate, and has a plurality of guide grooves on the lateral surface thereof, facing the second body 141.

A first guide groove 161 forms an elongated hole respectively at the upper side and the lower side of the third body 160, and is disposed in parallel, in the front-rear direction. A second guide groove 162 forms a curve-shaped hole on the lateral surface of the third body 160, and a third guide groove 163 forms a hole, elongated in the up-down direction, at the third body 160.

The link part 170 may connect the third body 160 and the second supporter 140, and modified in various different forms within the technical scope where the link shape of the link part 170 is changed by the front-rear movement of the second supporter 140. The link part 170 in one embodiment comprises a first link 171, a second link 172, and a link shaft 174.

The first link 171 is elongated in a straight line shape, and the second link 172 may rotatably connect to the first link, across the first link 171. The first link 171 and the second link 172 are installed in an “X” shape, and the portion where the first link 171 and the second link 172 cross each other is rotatably connected by the link shaft 173. Further, one side of the first link 171 and one side of the second link 172 may connect to the shaft 180.

The shaft 180 may connect the link 170 disposed on both lateral surfaces of the second supporter 140. The shaft 180 is formed into a rod, and elongated in the widthwise direction of the second supporter 140. The shaft 180 in one embodiment may comprise a first shaft 182 and a second shaft 184. The second shaft 184 is disposed at the lower side of the first shaft 182, and the first shaft 182 and the second shaft 184 are installed in parallel. Additionally, the first link 171 connects to the first shaft 182, and the second link 172 connects to the second shaft 184.

The first shaft 182 and the second shaft 184 are connected to each other by the elastic member 190. Thus, in the case where a distance between the first shaft 182 and the second shaft 184 is a predetermined distance or greater, the distance may be restored to the predetermined distance by the restoring force of the elastic member 190. The elastic member 190 in one embodiment uses a coil spring.

The movement guide 200 is disposed inside the third body 160, and has a hole to which the first shaft 182 and the second shaft 184 respectively connect. Additionally, the movement guide 200 may be modified in various different forms within the technical scope where the movement guide 200 guides the up-down movement of the first shaft 182. The movement guide 200 in one embodiment may comprise a movement guide body 201, an operation guide hole 202 and a fixation hole 204.

The movement guide body 201 is formed into a block that is elongated in the up-down direction, and the operation guide hole 202 and the fixation hole 204 are provided inside the movement guide body 201. The operation guide hole 202 is formed into an elongated hole that is elongated in the up-down direction, and the first shaft 182 is installed in the operation guide hole 202. The fixation hole 204 is disposed at the lower side of the operation guide hole 202, and the second shaft 184 is installed in the fixation hole 204.

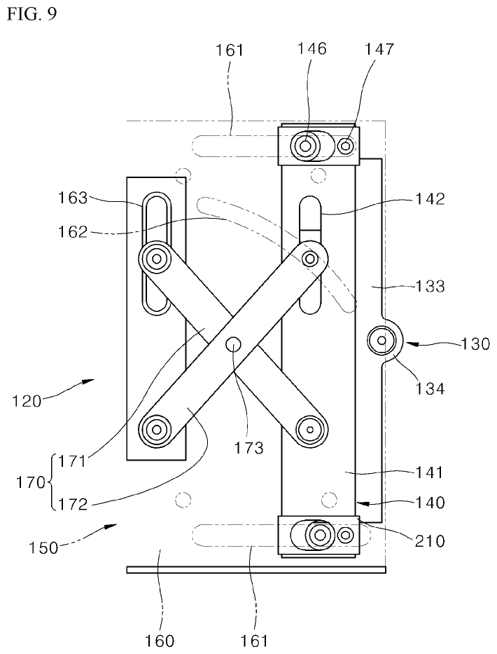

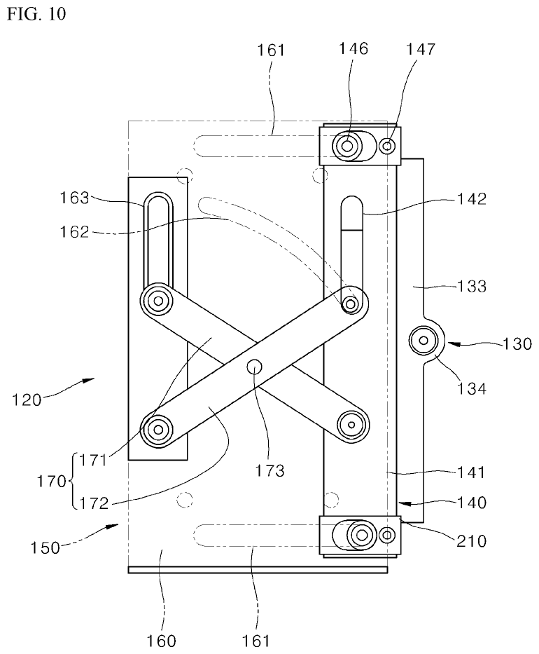

FIG. 9 is a view showing a connection state of a link part 170 in one embodiment, and FIG. 10 is a view showing the link part 170 in the state where the first supporter 130 moves forward in one embodiment.

The link part 170 and the shaft 180 are installed as illustrated in FIGS. 4, 9 and 10. That is, the end portion of the first shaft 182 passes through the first link 171 and then is disposed in the third guide groove 163. The first shaft 182 disposed in the third guide groove 163 is installed in the horizontal direction while passing through an operation guide groove provided at the movement guide 200. Accordingly, the first shaft is installed in a way that the first shaft can move along the third guide groove 163 and the operation guide groove, in the up-down direction.

The end portion of the second shaft 184 is mounted in the third body 160 after passing through the second link 172. The second shaft 184 is installed in the horizontal direction while passing through the fixation hole 204 provided at the movement guide 200. Thus, the movement of the second shaft is limited.

The upper side of the first link 171 connects to the first shaft 182, and the lower side rotatably connects to the lateral surface of the second body 141. The upper side of the second link 172 is disposed in a position where the upper side of the second link 172 faces the second guide groove 162 of the third body 160. Both sides of an additional connection projection is disposed respectively inside a side guide hole 142 and the second guide groove 162 that are provided at the lateral surface of the second body 141, while penetrating the upper side of the second link 172. Thus, as the upper side of the second link 172 moves along the second guide groove 162, the second body 141 moves to the front or the rear of the third body 160.

At this time, since the first side projection 146 protruding from the lateral surface of the second body 141 is disposed inside the first guide groove 161, the second supporter 140 may stably move in the front-rear direction.

A movement block 210 is disposed between the second body 141 and the third body 160 and fixed to the second side projection 147. The movement block 210 in one embodiment is a rectangular cuboid-shaped block, and has a first block hole into which the second side projection 147 is inserted, and a second block hole into which the first side projection 146 is inserted.

The charging device, structured as described above and provided at the personal mobility vehicle 300, in one embodiment, provides a docking structure capable of controlling the up-down direction, the front-rear direction and the rotation direction. Accordingly, since the first charging unit 30 may move based on the installation angle and position of the second charging unit 70 disposed at the personal mobility vehicle 300 of different models, docking reliability and charging efficiency may improve. Additionally, identical docking reliability may be ensured despite the product tolerance of the personal mobility vehicle 300, the position of the personal mobility vehicle 300 held at the stand 10, and the unevenness of the ground surface on which the stand 10 is disposed.

As illustrated in FIGS. 1 and 2, the personal mobility vehicle 300 comprises a handle 301 to which the manipulation force of the user is input, and a rotation column 302 which is elongated to the lower side of the handle 301 and rotates together with the handle 301. A first charging unit 30 may be fixed to the rotation column 302. Alternatively, after a charging bracket 310 is fixed to the rotation column 302, a second charging unit 70 may be fixed to the charging bracket 310.

A front wheel 303 is rotatably supported at the lower side of the handle 301, and a rear wheel 304 is rotatably disposed at a deck 305 connecting to the rotation column 302. The wheels of the personal mobility vehicle 300 may comprise a front wheel 303, and a rear wheel 304, and when necessary, may comprise additional wheels.

At least any one of the front wheel 303 and the rear wheel 304 is supplied with the driving force of a motor and rotates, and the motor is supplied with a power source through a battery installed in the deck 305. The battery may be supplied with a power source by connecting to the second charging unit 70.

A charging device 1 for a personal mobility vehicle in the present disclosure is fixed to a certain position. Accordingly, the personal mobility vehicle 300 may be readily taken and taken back. Additionally, the first charging unit 30 and the second charging unit 70 are charged with a magnetic field, thereby reducing the risk of accidents caused by electric leakage and electric shock.

An electric scooter is provided as an example of the personal mobility vehicle 300, but the personal mobility vehicle is not limited. Another type of mobility device can be the personal mobility vehicle 300 in the present disclosure.

Hereafter, the operation state of the charging device 1 for a personal mobility vehicle in one embodiment is described with reference to the accompanying drawings.

As illustrated in FIGS. 1 and 2, the front wheel 303 of the personal mobility vehicle 300 moves along a guide member 22 of a second guide 20. The front wheel 303 moves along a guide groove 24, and the personal mobility vehicle 300 moves to a stand 10 at which the first charging unit 30 is disposed. Since the guide member 22 supports both lateral surfaces of the front wheel 303, the personal mobility vehicle 300 may be stored in an upright position.

Additionally, wireless charging is performed in the state where the second charging unit 70 contacts the first charging unit 30 or is spaced from the first charging unit 30 within a predetermined distance, as illustrated in FIGS. 1 and 6. A transmission coil 60 supplied with a power source through a transmission controller 50 generates a magnetic field for generation electricity. The magnetic field of the transmission coil 60 is delivered to a reception coil 100, converted into a power source in a reception controller 90, and then delivered to a battery of the personal mobility vehicle 300, to charge the battery.

Since the battery of the personal mobility vehicle 300 is charged based on wireless charging, it has versatility regardless of the shape of a wired charging port, and thus a charging docking station capable of responding to devices of all manufacturers can be provided.

As illustrated in FIG. 6, the second charging unit 70 is disposed at the front of the first charging unit 30, and in the case where a first magnet 65 provided at the first charging unit 30, and a second magnet 110 provided at the second charging unit 70 are disposed side by side, the first charging unit 30 and a first supporter 130 do not move up and down. At this time, a first elastic supporter 144 and a second elastic supporter 145 are maintained in an initial state where any one side of the first elastic supporter 144 and the second elastic supporter 145 is compressed.

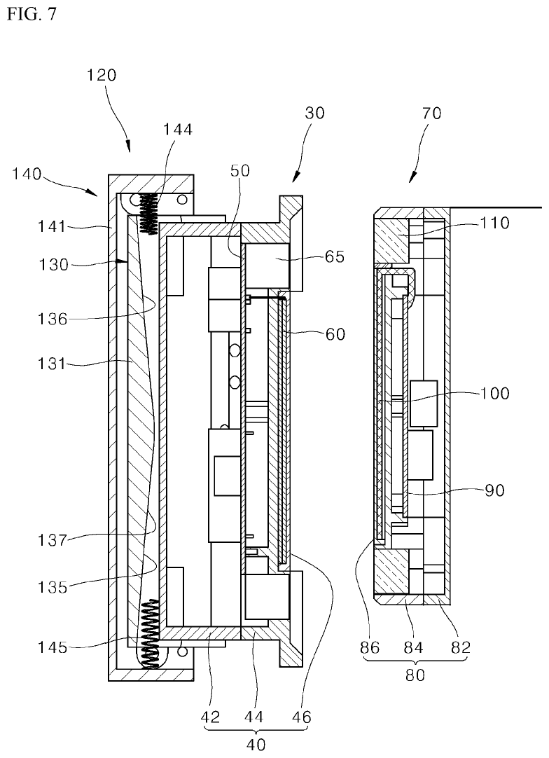

FIG. 7 is a cross-sectional view showing that the first charging unit 30 moves upward along the second charging unit 70 in one embodiment.

As illustrated in FIG. 7, the second charging unit 70 is disposed at the front of the first charging unit 30, and in the case where the second magnet 110 provided at the second charging unit 70 is disposed further upward than the first magnet 65 provided at the first charging unit 30, the first charging unit 30 moves upward. Since attractive force is applied between the first magnet 65 and the second magnet 110, the first charging unit 30 provided with the first magnet 65 moves upward, to face the second charging unit 70.

As the first charging unit 30 moves upward, the first supporter 130 supporting the first charging unit 30 moves upward together with the first charging unit 30. Accordingly, the first elastic supporter 144 disposed at the upper side of the first supporter 130 is compressed, and the length of the second elastic supporter 145 disposed at the lower side of the first supporter 130 increases because of a decrease in the compressive force.

Further, the first elastic supporter 144 and the second elastic supporter 145 are supported by a guide bar 143, and in FIG. 7, the guide bar 143 is omitted.

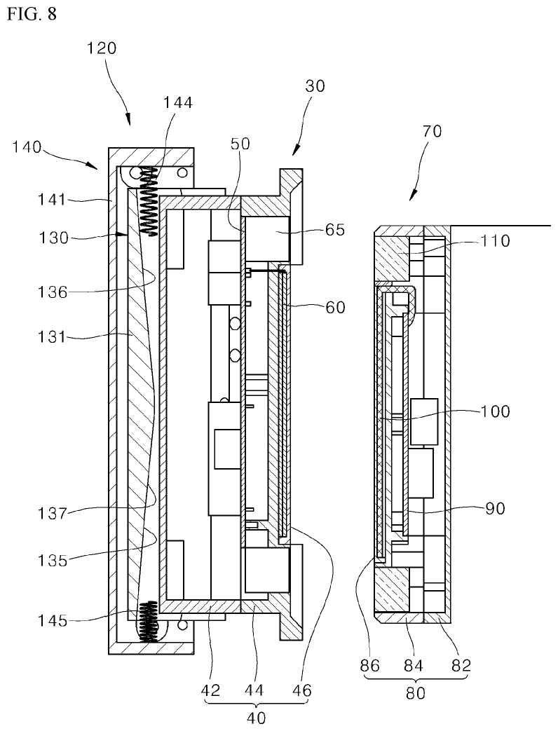

FIG. 8 is a cross-sectional view showing that the first charging unit 30 moves downward along the second charging unit 70 in one embodiment.

As illustrated in FIG. 8, the second charging unit 70 is disposed at the front of the first charging unit 30, and in the case where the second magnet 110 provided at the second charging unit 70 is disposed further downward than the first magnet 65 provided at the first charging unit 30, the first charging unit 30 moves downward. Since attractive force is applied between the first magnet 65 and the second magnet 110, the first charging unit 30 provided with the first magnet 65 moves downward, to face the second charging unit 70.

As the first charging unit 30 moves downward, the first supporter 130 supporting the first charging unit 30 moves downward together with the first charging unit 30. Thus, as the force of compressing the first elastic supporter 144 at the upper side of the first supporter 130 decreases, the up-down length of the first elastic supporter 144 increases. Additionally, since the second elastic supporter 145 at the lower side of the first supporter 130 is compressed, the up-down length of the second elastic supporter 145 decreases.

As described above, the first charging unit 30 may move up and down, based on the operation of the first elastic supporter 144 and the second elastic supporter 145 provided in a variable support unit 120, and the first magnet 65 provided in the first charging unit 30 and the second magnet 110 provided in the second charging unit 70.

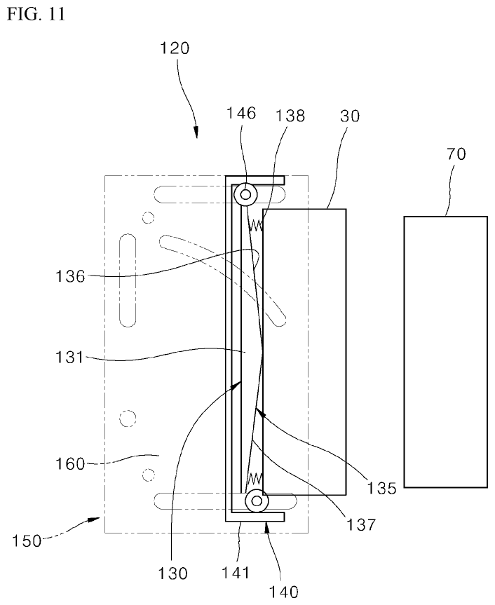

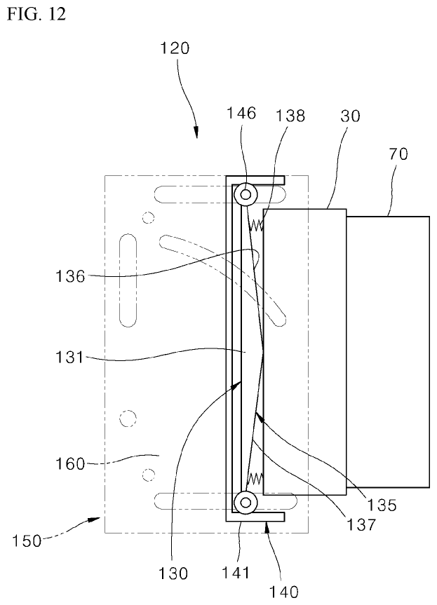

FIG. 11 is a view showing that the first charging unit 30 is disposed at the first supporter 130 in one embodiment, and FIG. 12 is a view showing that the second charging unit 70 contacts the first charging unit 30 in one embodiment.

As illustrated in FIGS. 1, 11 and 12, as the personal mobility vehicle 300 is held at the stand 10, the second charging unit 70 contacts the first charging unit 30. Since the second magnet 110 is installed inside the second charging unit 70 while the first magnet 65 is installed inside the first charging unit 30, the contact between the first charging unit 30 and the second charging unit 70 may remain reliable.

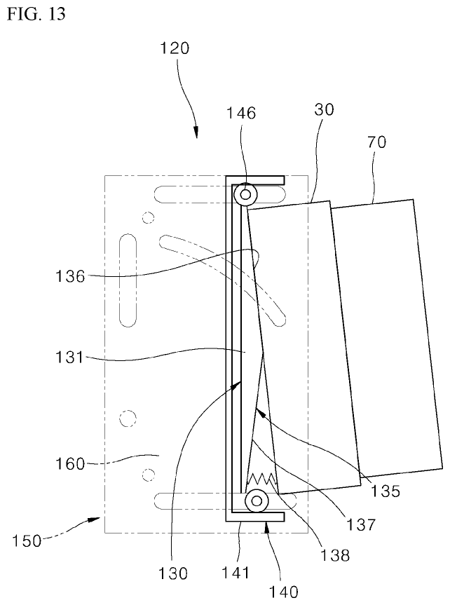

FIG. 13 is a view showing that the first charging unit 30 is in contact with the second charging unit 70 while rotating, in one embodiment.

As illustrated in FIG. 13, in the case where the second charging unit 70 moves toward the first charging unit 30, in an inclination state rather than in an upright position, the first charging unit 30 inclines in the state of contacting the second charging unit 70. The first supporter 130 supporting the first charging unit 30 may rotate in the direction where the first supporter 130 contacts an upper inclination part 136 or where the first supporter 130 contacts a lower inclination part 137.

Since the first supporter 130 is supported by a buffer member 138, the first charging unit 30 and the second charging unit 70 may keep contacting each other reliably.

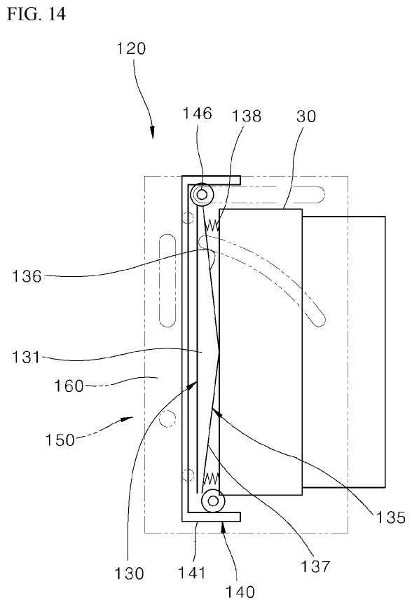

FIG. 14 is a view showing that the first charging unit 30 is moved toward the inside of a third body 160 in one embodiment.

As illustrated in FIG. 14, in the case where the second charging unit 70 moves past a predetermined position and pressurizes the first charging unit 30 toward the inside of the third body 160, the first supporter 130 and the second supporter 140 move rearward along the third body 160. Accordingly, the first charging unit 30 and the second charging unit 70 surface-contact each other, such that a power source is delivered readily through a magnetic field.

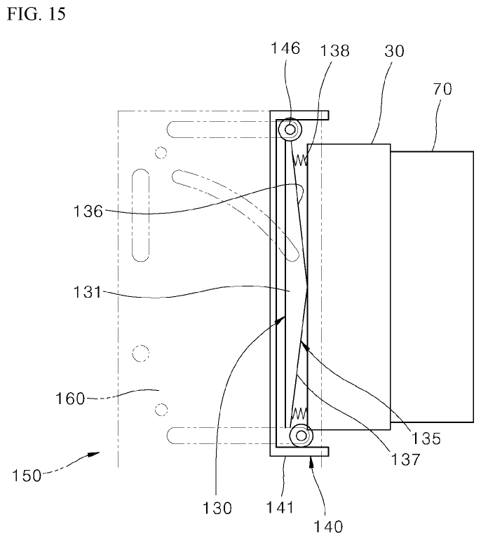

FIG. 15 is a view showing that the first charging unit 30 is moved toward the outside of the third body 160 in one embodiment.

As illustrated in FIG. 15, in the case where the second charging unit 70 moves far from the first charging unit 30, the first charging unit 30 contacting the second charging unit 70 is moved to the front of the third body 160 by magnetic force, together with the second charging unit 70.

As illustrated in FIGS. 9 and 10, the first charging unit 30 moves in the front-rear direction as the link part 170 moves along a second guide groove 162 and a third guide groove 163 provided at the third body 160. Additionally, since a first side projection 146 provided at the second supporter 140 moves along a first guide groove 161 provided at the third body 160, the front-rear movements of a first measuring unit, the first supporter 130 and the second supporter 140 may be ensured reliably.

Further, the first charging unit 30 may rotate around the first supporter 130 within predetermined angles, depending on the position of the second charging unit 70. Accordingly, the first charging unit 30 and the second charging unit 70 may contact each other reliably. Thus, the first charging unit 30 and the second charging unit 70 may surface-contact each other, and a power source may be delivered readily through a magnetic field.

The charging device 1 for a personal mobility vehicle in the present disclosure helps to ensure improvement in charging efficiency, since the first charging unit 30 can move based on the position of the second charging unit 70. Specifically, even if the second charging unit 70 is not in a predetermined position due to tolerance that may be generated as a personal mobility vehicle 300 is assembled, the first charging unit 30 moves based on the position of the second charging unit 70, ensuring improvement in charging efficiency. Further, even if the second charging unit 70 is not in the predetermined position because the user fails to store the personal mobility vehicle 300 at the stand 10, the first charging unit 30 can move to be aligned with the second charging unit 70. Further, even if the stand 10 is disposed on the ground surface that is inclined or not flatted, the first charging unit 30 moves to be aligned with the second charging unit 70, ensuring improvement in charging efficiency. Furthermore, a reliable docking structure can be provided for a personal mobility vehicle 300 of different models, manufactured by different manufacturers.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the scope of the disclosure though not explicitly described in the description of the embodiments.

1-20. (canceled)

21. A charging device for a personal mobility vehicle, the charging device comprising:
a first charger configured to create a magnetic field for wireless charging;
a second charger mounted on the personal mobility vehicle, and configured to convert the magnetic field that is created by the first charger into a power source, and charge a battery provided in the personal mobility vehicle;
a stand configured to store the personal mobility vehicle in an upright position; and
a variable support fixed to the stand, and configured to support the first charger, and move the first charger, based on a position of the second charger.

22. The charging device of claim 21, wherein the variable support comprises:
a first supporter configured to support the first charger to be rotatable.

23. The charging device of claim 22, wherein the first supporter comprises:
a body spaced apart from the first charger and elongated in an up-down direction;
a side member elongated from both sides of the body toward a front of the body at which the first charger is disposed, and configured to support the first charger to be rotatable; and
a stopper protruding toward the front of the body to contact the first charger that rotates at an angle greater than or equal to a predetermined angle, and configured to limit a rotation of the first charger.

24. The charging device of claim 23, wherein the first supporter further comprises a buffer member disposed between the stopper and the first charger, and configured to reduce an impact at a time at which the first charger rotates toward the stopper.

25. The charging device of claim 22, wherein the variable support further comprises a second supporter disposed outside the first supporter, and configured to guide an up-down movement of the first supporter.

26. The charging device of claim 25, wherein the second supporter comprises:
a body disposed to surround a lateral surface and a rear of the first supporter;
a guide bar fixed to the body and passing through the first supporter in an up-down direction;
a first elastic supporter disposed between an upper side of the first supporter and the body, and configured to pressurize the first supporter downward; and
a second elastic supporter disposed between a lower side of the first supporter and the body, and configured to pressurize the first supporter upward.

27. The charging device of claim 25, further comprising:
a third supporter disposed outside the second supporter, mounted on the stand, and configured to guide a front-rear movement of the second supporter.

28. The charging device of claim 27, wherein the third supporter comprises:
a body disposed outside the second supporter and fixed to the stand;
a link which connects the body and the second supporter, and has a link shape which changes based on the front-rear movement of the second supporter; and
a shaft connecting the link that is disposed on a lateral surface of the second supporter.

29. The charging device of claim 28, wherein the link comprises:
a first link elongated in a shape of a straight line; and
a second link rotatably connected to the first link, and crossing the first link,
wherein a side of the first link and a side of the second link connect to the shaft.

30. The charging device of claim 29, wherein the shaft comprises:
a first shaft connected to the first link; and
a second shaft disposed in parallel with the first shaft, and connected to the second link.

31. The charging device of claim 21, wherein the first charger comprises:
a housing fixed to the stand;
a transmission controller installed inside the first housing; and
a transmission coil disposed inside the first housing, and configured to connect to the transmission controller.

32. The charging device of claim 21, wherein the second charger comprises:
a housing fixed to the personal mobility vehicle;
a reception controller installed inside of the second housing; and
a reception coil disposed inside the second housing, and configured to connect to the reception controller.

33. A charging device for a personal mobility vehicle, the charging device comprising:
a first charger configured to create a magnetic field for wireless charging;
a second charger configured to convert the magnetic field that is created by the first charger into a power source, and charge a battery provided in a personal mobility vehicle; and
a variable support configured to support the first charger, and move the first charger, based on a position of the second charger,
wherein in a state where the first charger and the second charger do not contact each other, a position of the first charger varies depending on the position of the second charger.

34. The charging device of claim 33, wherein the first charger comprises:
a first housing fixed to a stand that supports the personal mobility vehicle;
a transmission controller installed inside the first housing;
a transmission coil disposed inside the first housing, and configured to connect to the transmission controller; and
a first magnet fixed to the first housing, and configured to produce a magnetic force.

35. The charging device of claim 34, wherein the second charger comprises:
a second housing fixed to the personal mobility vehicle;
a reception controller installed inside of the second housing;
a reception coil disposed inside the second housing, and configured to connect to the reception controller; and
a second magnet fixed to the second housing, and configured to produce a magnetic force of a polarity different from a polarity of the magnetic force produced by the first magnet.

36. The charging device of claim 33, wherein the variable support comprises:
a first supporter configured to support the first charger to be rotatable;
a second supporter disposed outside the first supporter, and configured to guide an up-down movement of the first supporter; and
a third supporter disposed outside the second supporter, mounted on a stand that supports the personal mobility vehicle, and configured to guide a front-rear movement of the second supporter.

37. The charging device of claim 36, wherein the first supporter comprises:
a body spaced apart from the first charger and elongated in an up-down direction;
a side member elongated from both sides of the body toward a front of the body at which the first charger is disposed, and configured to support the first charger to be rotatable;
a stopper protruding toward the front of the first body to contact the first charger that rotates at an angle greater than or equal to a predetermined angle, and configured to limit a rotation of the first charger; and
a buffer member disposed between the stopper and the first charger, and configured to reduce an impact at a time at which the first charger rotates toward the stopper.

38. The charging device of claim 36, wherein the second supporter comprises:
a body disposed to surround a lateral surface and a rear of the first supporter;
a guide bar fixed to the second body and passing through the first supporter in an up-down direction;
a first elastic supporter disposed between an upper side of the first supporter and the body, and configured to pressurize the first supporter downward; and
a second elastic supporter disposed between a lower side of the first supporter and the body, and configured to pressurize the first supporter upward.

39. The charging device of claim 38, wherein an elastic force of the second elastic supporter is greater than an elastic force of the first elastic supporter.

40. The charging device of claim 36, wherein the third supporter comprises:
a body disposed outside the second supporter and fixed to the stand;
a link which connects the body and the second supporter, and has a link shape which changes based on the front-rear movement of the second supporter; and
a shaft connecting the link that is disposed on a lateral surface of the second supporter.
